(19) United States
(12) Patent Application Publication
(10) Pub. No.: US 2008/0037276 A1
(43) Pub. Date: Feb. 14, 2008

(54) Lighting fixture

(75) Inventors: Gwo-Juh Tzeng, Chung Li (TW); Hsiao Fan-Cheng, Chung Li (TW)

Correspondence Address: TROXELL LAW OFFICE PLLC, SUITE 1404, 5205 LEESBURG PIKE, FALLS CHURCH, VA, 22041, US

(73) Assignee: Taiwan Nano Electro-optical Technology Co., Ltd.

(21) Appl. No.: 11/502,531

(22) Filed: Aug. 11, 2006

(51) Int. Cl. F21V 7/04

(52) U.S. Cl. 362/610

(57) ABSTRACT

A lighting fixture includes a backlight module comprised of a light diffusion board and multiple light guide sticks arranged on multiple sides of the light diffusion board and multiple point light sources respectively oriented in facing those light guide sticks to guide light streams emitted form those point light sources to the light diffusion board for increasing the luminance and creating visual effects of generalized glow.

### BACKGROUND OF THE INVENTION

(a) Field of the Invention

The present invention is related to a lighting fixture, and more particularly, to one that creates consistent luminance visual effect.

(b) Description of the Prior Art

Referring to FIG. 1 of the accompanying drawings for a patent application Ser. No. 595,732 published, a CCFL(Cold Cathode Fluorescent Lamp)12 is disposed to an incident plane 111 of a light guide board 11, and both ends of the incident plane are respectively provided with one LED(Light Emiting Doide) 13. The LEDs 13 serve as auxiliary light sources and are directly disposed on the light guide board 11 to make sure that there is the absence of dark angle for light emission. However, since both LEDs 13 directly emit light on the light guide board 11, the traveling direction of the light streams will be affected by the incident angle to fail consistent glow, thus to prevent them from serving as the primary light source. Therefore, the CCFL 12 with higher luminance must serve as the primary light source for the entire luminance and glow to meet requirements. However, the drive circuit of the CCFL 12 is comparatively complicated to prevent it from working under lower temperature and its response time is too long to meet market demands.

To correct the defectives, U.S. Pat. No. 6,474,826 is essentially comprised of a light guide stick 22 disposed on one side of a light diffusion board 21 and two LEDs 23 are then disposed on one side or two end surfaces of the light guide stick 22. Accordingly, the light guide stick 22 guides the light streams emitted from those two LEDs 23 to the light diffusion board 21 in a beeline direction to enhance the luminance. However, the construction described above though allow the direct use of the LED 23 as the primary light source; in practice, there are the following defects pending further improvements.

Referring to FIG. 2 and Attachment 1, whereas both of the light guide stick 22 and the LED 23 are provided on one side of the light diffusion board 21, the luminance weakens as the distance gets longer for the light diffusion board 21 to produce the phenomenon of light and share, resulting in local shadow and affected glow there.

Therefore, to upgrade the luminance from other positions, multiple ribs 212 are created on a surface 211 of the light diffusion board 21 to originate light refraction, thus to improve the luminance at where darker. However, reflection by those ribs 212 at the same time deflects the light streams otherwise going straight. As a result, the luminance for certain parts is increased, but that on other parts is reduced to create the phenomenon of light and shade and the defect of inconsistent glow.

Furthermore, there are only two diodes provided as taught in U.S. Pat. No. 6,474,826 to prevent sufficient luminance for the lighting fixture while the market trends tend to demand larger dimension and higher luminance.

### SUMMARY OF THE INVENTION

The primary purpose of the present invention is to provide a light fixture that is capable of upgrading luminance and maintaining consistent glow.

To achieve the purpose, the present invention is comprised of a backlight module and multiple point light source. The backlight module includes a light diffusion board and multiple light guide sticks; and those light guide sticks are disposed on multiple sides of the light diffusion board to increase the luminance of the light fixture of the present invention while creating visual effects of generalized glow.

### BRIEF DESCRIPTION OF THE DRAWINGS

FIG. 1 is a perspective view of a backlight module of the prior art.

FIG. 2 is a perspective view of a backlight module of the present invention.

FIG. 3 is a bird's view showing a first preferred embodiment of the present invention.

FIG. 4 is a side view showing a light guide stick and multiple LEDs in the first preferred embodiment of the present invention.

FIG. 5 is a bird's view showing a second preferred embodiment of the present invention.

FIG. 6 is a bird's view showing a third preferred embodiment of the present invention.

FIG. 7 is a bird's view showing a fourth preferred embodiment of the present invention.

FIG. 8 is a bird's view showing a fifth preferred embodiment of the present invention.

FIG. 9 is a bird's view showing a sixth preferred embodiment of the present invention.

FIG. 10 is a bird's view showing a seventh preferred embodiment of the present invention.

FIG. 11 is a bird's view showing an eighth preferred embodiment of the present invention.

FIG. 12 is a sectional view showing the relative locations between the eighth preferred embodiment and two reflective masks.

Attachment 1: Luminance Distribution Profile of the second prior art.

Attachment 2: Luminance Distribution Profile of the Present invention.

### DETAILED DESCRIPTION OF THE PREFERRED EMBODIMENTS

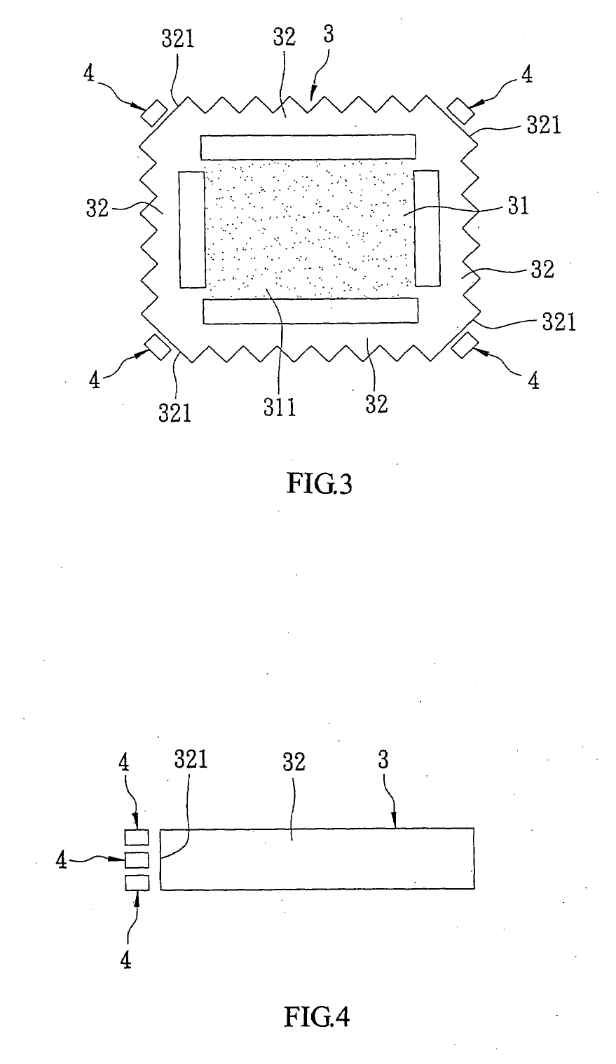

Referring to FIGS. 3 and 4, a first preferred embodiment of the present invention includes a backlight module 3 and multiple point light sources 4. The backlight module 3 includes a light diffusion board 31 and four light guide sticks 32. The light diffusion board 31 includes multiple net dots 311 on its surface. Those light guide sticks 32 are made integrated with and arranged on four sides of the light diffusions board 31.

Those point light sources respectively arranged on any two abutted end surfaces 321 of those light guide sticks 32 in the first preferred embodiment are each related to an LED 4 and are facing toward those light guide sticks 32 so to guide light streams emitted from those LEDs 4 to the light diffusion board 31.

Whereas those LEDs 4 are arranged on the peripheral of the light diffusion board 31, the problem of weakening luminance found with the prior art is corrected. Meanwhile, the light streams emitted from those LEDs 4 radiate into the light diffusion board 31 as guided by those light guide sticks 32. While effectively upgrading the general luminance, the consistent glow is generally achieved in conjunction with the layout of those net dots 311 for the entire glow to create generalized visual effects as indicated in Attachment 2.

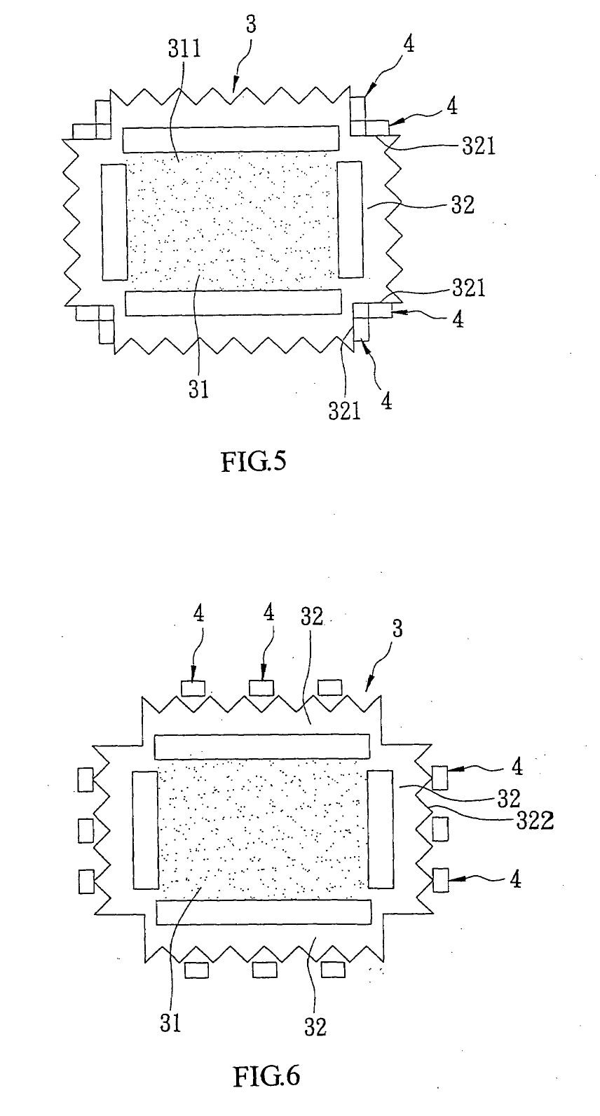

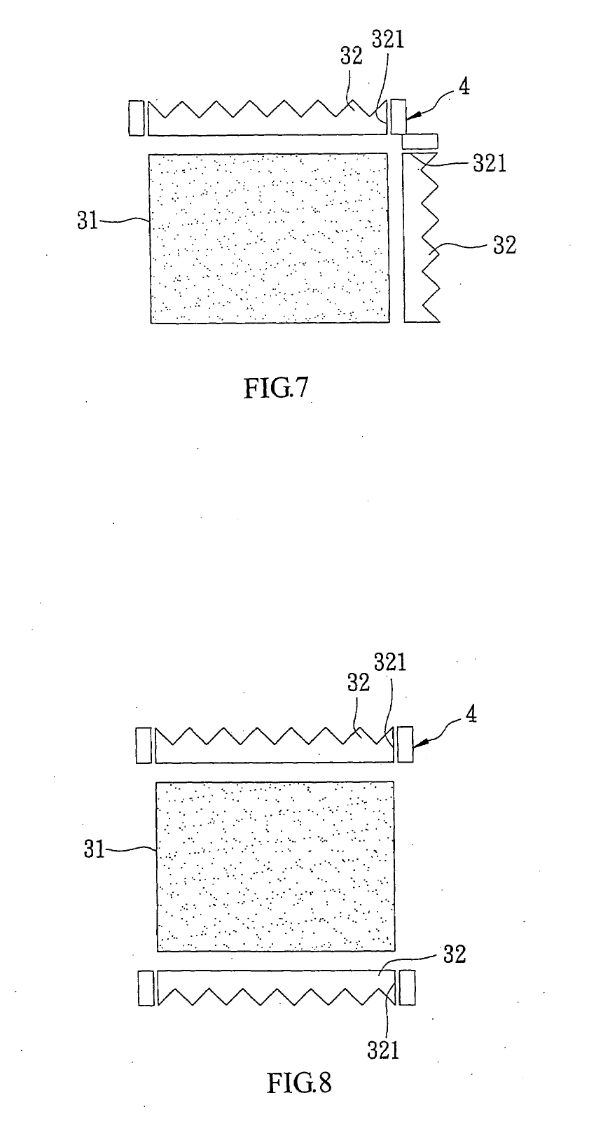

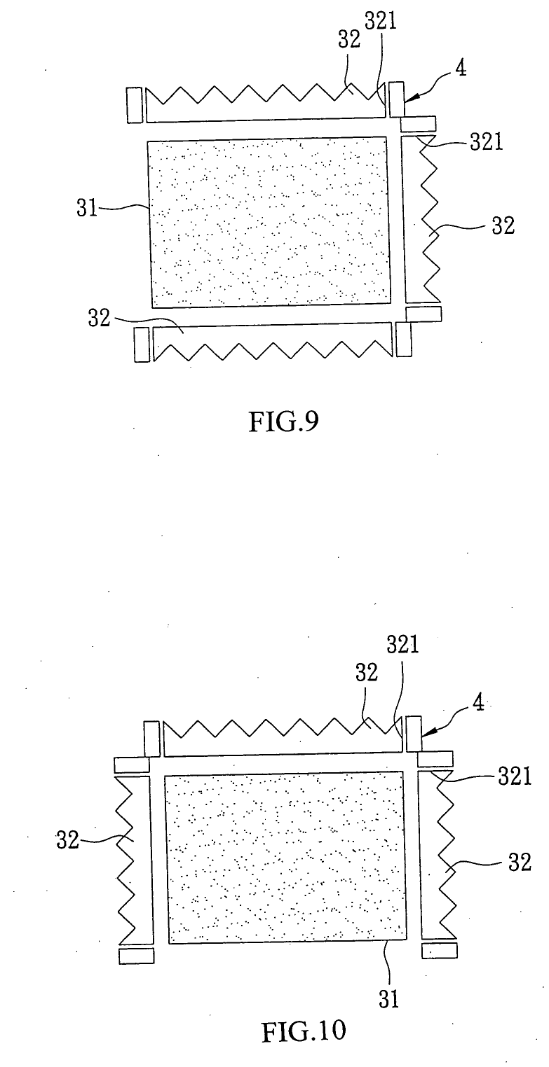

Alternatively, those LEDs 4 may be arranged on any two end surfaces 321 of those light guide sticks 32 that are abutted to each other at right angel as illustrated in FIG. 5; or arranged on each outer side 322 in facing those light guide sticks as illustrated in FIG. 6. When there are only two light guide sticks 32 disposed to and separated from the light diffusion board 31, those two light guide sticks 32 are arranged on any two sides of the light diffusion board 31; and as respectively illustrated in FIGS. 7 and 8, those two LEDs 4 are arranged on two end surfaces 321 abutted to each other at right angle when both light guide sticks 32 are not disposed on opposite sides of the light diffusion board 31. Similarly as illustrated in FIGS. 9 and 10 when three light guide sticks 4 are provided, they are arranged on any three sides of the diffusion board 31 and in case of any abutted sides those LEDs 4 are arranged on two end surfaces 321 abutted at right angle. In any arrangement as described above, it effectively upgrades the luminance and creates consistent glow for the entire lighting fixture.

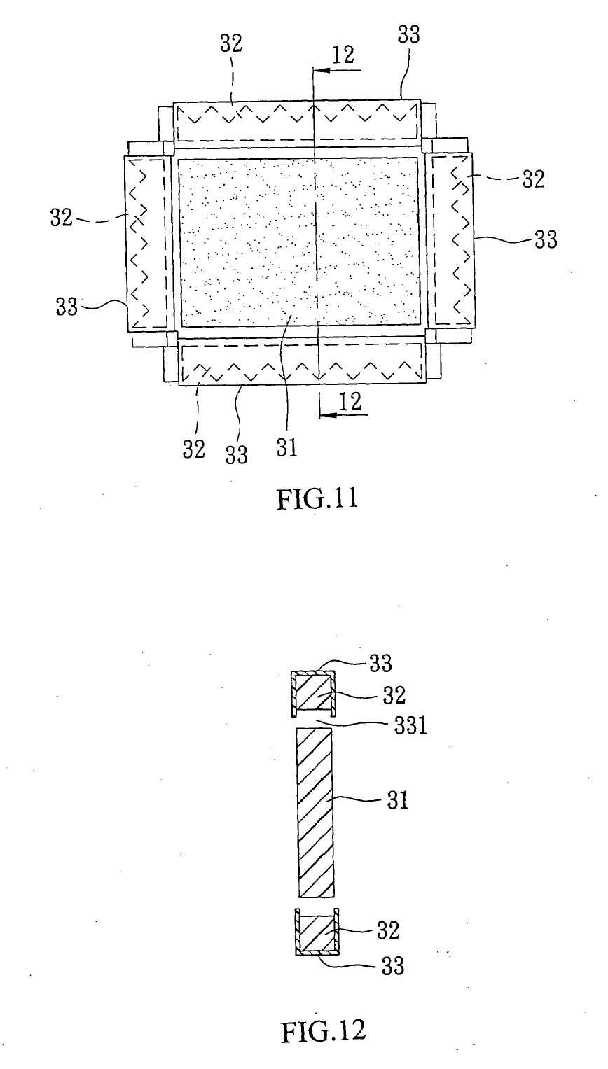

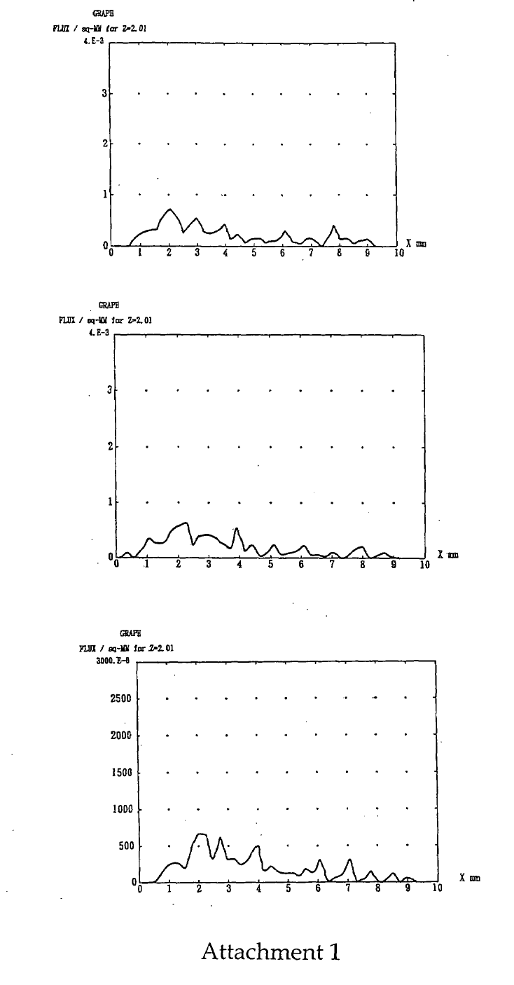

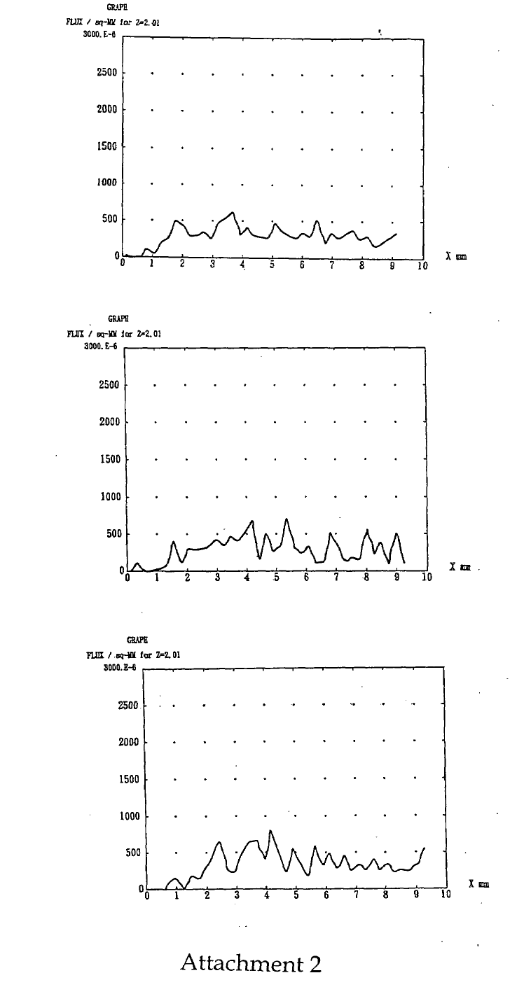

Now referring to FIGS. 11 and 12, multiple reflection masks 33 are provided to the backlight module depending on the quantity of the light guide stick 32. Each light guide stick 32 is screened by one reflection mask 33. An opening 331 in facing the light diffusion board 31 is disposed to each reflection mask 33. Light streams from the light guide stick 31 is screened by the reflective mask 33 and reflected back to the light guide stick 32 before being collectively guided by those light guide sticks 32 into the light diffusion board 31 to significantly reduce the light loss while effectively upgrading the luminance and achieving consistent glow for the entire lighting fixture.

As described above, a lighting fixture of the present invention provided the following advantages and results:

1. Whereas the present invention has the LED 4 as the direct light source, a summary drive circuit is sufficient and operation under low temperature is feasible. It is more susceptible to temperature difference, more resisting to normal tear and wear, and providing longer service life to meet market demands.

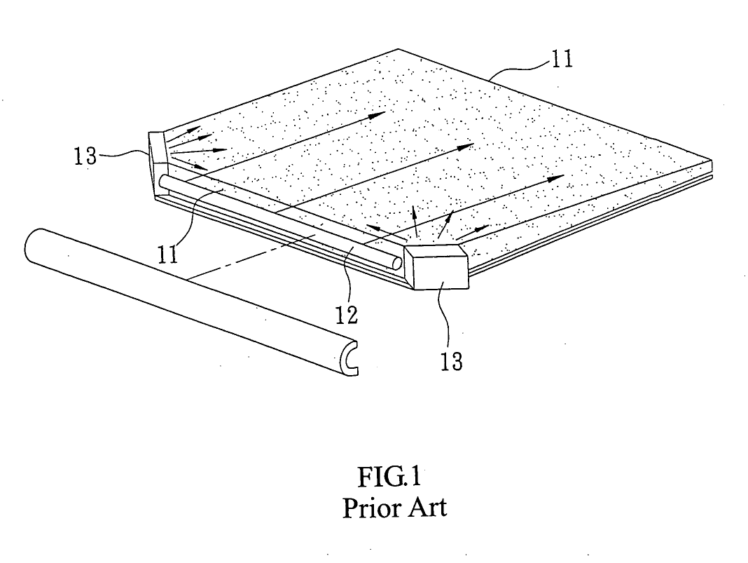

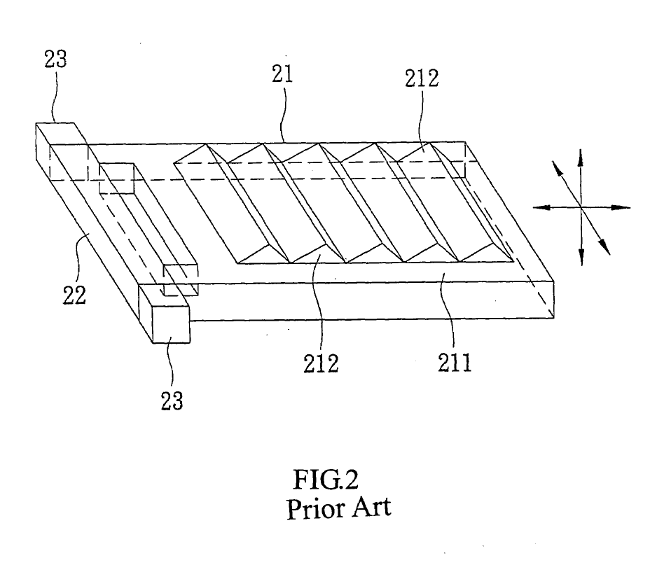

2. The problem of weakening luminance as found with the prior art can be significantly improved by the present invention since the light source in the present invention is provided by multiple LEDs 4 arranged on the peripheral of the light diffusion board 31; and light streams emitted from those LEDs 4 are concentrated by multiple reflection masks 33 before being collectively guided to radiate into the light diffusion board 31 to effectively upgrade the general luminance without the necessity of those additional ribs found with the prior art. When compared to those prior arts as illustrated in FIGS. 1 and 2, the backlight module of the present invention allows simplified assembly and manufacturing process, longer service life, and better resistance to normal tear and wear while creating visual effects of generalized glow.

The present invention provides an improved structure of a lighting fixture, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A lighting fixture includes a backlight module containing a light diffusion board and multiple light guide sticks mounted on multiple sides of the light diffusion board; and multiple point light sources respectively oriented toward light guide sticks where light emitted from point light sources is guided to the diffusion board.

2. The lighting fixture as claimed in claim 1, wherein each point light source relates to a light emitting diode.

3. The lighting fixture as claimed in claim 1, wherein those point light sources are disposed at two end surfaces of those light guide sticks.

4. The lighting fixture as claimed in claim 1, wherein those point light sources are disposed on an outer side of those light guide sticks.

5. The lighting fixture as claimed in claim 1, wherein the diffusion board is integrated with those light guide sticks.

6. The lighting fixture as claimed in claim 1, wherein the light diffusion board is provided with multiple net dots on its surface.

7. The lighting fixture as claimed in claim 1, wherein the backlight module is further provided with multiple reflection masks depending on the quantity of the light guide stick; those light guide sticks are respectively screened by the masks, and each mask is disposed with an opening oriented towards the light diffusion board.
